(19) United States
(12) Patent Application Publication
(10) Pub. No.: US 2016/0131957 A1
(43) Pub. Date: May 12, 2016

(54) ELECTROPHORETIC DISPLAY HAVING CHARGED FLUORESCENT DENDRIMER PARTICLES

(71) Applicant: EMPIRE TECHNOLOGY DEVELOPMENT LLC, Wilmington, DE (US)

(72) Inventor: Josef Peter KLEIN, Vashon, WA (US)

(73) Assignee: EMPIRE TECHNOLOGY DEVELOPMENT LLC, Wilmington, DE (US)

(21) Appl. No.: 14/901,630

(22) PCT Filed: Jun. 26, 2013
(86) PCT No.: PCT/US2013/047903

§ 371 Date: Dec. 28, 2015

(51) Int. Cl. G02F 1/167; C09B 67/00

(52) U.S. Cl. CPC G02F 1/167; C09B 68/46775; G02F 2001/1678; G02F 2001/1676

(57) ABSTRACT

Electrophoretic displays with an electrophoretic medium having charged fluorescent particles are disclosed. The charged fluorescent particles have a dendrimer core covalently bonded with fluorophores of various emissive wavelengths so that microparticles that emit a variety of different colored electromagnetic radiation may be produced. Methods for producing the microparticles and using the microparticles in an electrophoretic display are also disclosed. Such microparticles may be provided separately, or kits may be provided for producing the microparticles.

### BACKGROUND

Electrophoretic displays, such as those that may be used in e-reader devices or other display applications, are displays based on an electrophoresis phenomenon influencing charged color particles suspended in a dielectric solvent. The color particles may be of a size of about 1-2 microns in diameter, carrying a charge, and are able to migrate within the dielectric solvent under the influence of externally applied charges from adjacent electrode plates or conducting films. The color particles may provide at least one visible color in the display.

Electrophoretic displays have an electrophoretic fluid having at least one type of charged color particle dispersed in the dielectric solvent. The electrophoretic fluid may be pigmented with a color that is in contrast to the color particles, for example, white particles in a colorless or clear dielectric solvent. Upon application of a charge to the electrode plates, the color particles may be influenced to migrate towards or away from the electrode plates, by attraction to a plate of opposite charge, or repulsion from a plate of similar charge. In this manner, the color showing at one surface may be either the color of the solvent if the particles are attracted away from that surface, or may be the color provided by the particles if the particles are attracted to that surface. Reversal of plate polarity may then cause the particles to migrate back to the opposite plate, thereby reversing the color.

Alternatively, an electrophoretic fluid may have two types of color particles of contrasting colors (for example, white and black) and carrying opposite charges, dispersed in a clear solvent. Upon application of a voltage difference between two electrode plates, the two types of color particles may move to opposite ends (top or bottom) in a display cell. Thus, one or the other of the colors provided by the two types of color particles would be visible at the viewing side of the display cell.

The color-providing particles may be ionic or ionizable microparticles composed of white, black or otherwise colored molecules encapsulated by a polymer. The color-providing particles may be formed from a non-covalent bonding of a polymer matrix to the encapsulated colored molecules. The non-covalent bonding may be broken down by radiant energy, resulting in a loss of color over time and rendering the electrophoretic display no longer functioning as designed. In addition, molecules that have color because of dyes may not be exceptionally bright as these molecules simply reflect ambient light.

For electrophoretic displays, there remains a need for charged color-providing particles which have improved color-fastness and photostability, and which are able to provide brighter colors for the displays.

### SUMMARY

Micro- and nano-particle based approaches to electrophoretic displays employing charged fluorescent dendrimers can provide improved color-fastness and photostability. As the fluorescent dendrimers can emit light, they may also provide brighter colors for the displays.

In an embodiment, an electrophoretic display includes at least one first electrode layer and an electrophoretic medium disposed adjacent to the at least one first electrode layer. The electrophoretic medium includes at least one electrically charged particle disposed in a fluid and capable of moving through the fluid upon application of an electrical field to the fluid. The at least one charged particle includes a charged fluorescent dendrimer.

In an embodiment, a method of using an electrophoretic display includes providing an electrophoretic display to emit colored electromagnetic radiation from a surface of the display. The display includes at least one first electrode layer and an array of microcapsules disposed adjacent to the at least one first electrode layer with a first side of the microcapsules adjacent to the at least one first electrode layer and a second side of the microcapsules away from the at least one first electrode layer. Each of the microcapsules includes an electrophoretic medium having at least one electrically charged particle disposed in a fluid and capable of moving through the fluid upon application of an electrical field to the fluid. The at least one charged particle includes a charged fluorescent dendrimer. The method further includes selectively applying an electric charge to the first electrode layer adjacent to selected microcapsules in the array to cause the at least one charged particle in the selected microcapsules to move away from the first electrode layer to the second side of the selected microcapsules, and irradiating the display with electromagnetic radiation capable of fluorescing the at least one charged particle to emit colored electromagnetic radiation from the second side of the selected microcapsules.

In an embodiment, an electrophoretic medium includes at least one electrically charged particle disposed in a fluid and capable of moving through the fluid upon application of an electrical field to the fluid. The at least one charged particle includes a charged fluorescent dendrimer.

In an embodiment, a kit for producing charged fluorescent dendrimers includes core dendrimers and charged fluorophores configured to covalently bond with the dendrimers to form the charged fluorescent dendrimers.

In an embodiment, a charged fluorescent particle for an electrophoretic display includes at least one charged fluorophore covalently bonded to a dendrimer core, wherein the charged fluorophore is a derivative of a charged fluorophore molecule comprising at least one reactive functional group, and the dendrimer core is a derivative of a dendrimer molecule comprising at least one surface reactive functional group. One of the reactive functional groups and the surface reactive functional groups includes amine-reactive carbonyl groups, and the other one of the reactive functional groups and the surface reactive functional groups includes surface reactive amines.

In an embodiment, a method for producing charged fluorescent particles includes contacting charged fluorophores with dendrimers, wherein the fluorophores have at least one amine-reactive carbonyl group selected from the group comprising: aldehyde, ketone, carboxylic acid, ester, acyl halide, anhydride, and combinations thereof, and the dendrimers have at least one surface reactive amine. The surface reactive amines react with the at least one amine-reactive carbonyl group to covalently bond the dendrimers with the fluorophores to form the charged fluorescent particles.

### BRIEF DESCRIPTION OF THE FIGURES

FIGS. 1A-1C are representative configurations of an electrophoretic display according to an embodiment.

FIG. 2 depicts a representative dendrimer according to an embodiment.

FIGS. 3A and 3B depict schematic functionalized dendrimer cores for producing fluorescent dendrimers according to an embodiment.

FIG. 4 depicts fluorescent dyes that may be used for fluorescent dendrimers according to embodiments.

FIG. 5 depicts a schematic illustration of a method for producing charged fluorescent dendrimers according to an embodiment.

FIG. 6 depicts a schematic illustration of a method for producing charged fluorescent dendrimers according to an embodiment.

### DETAILED DESCRIPTION

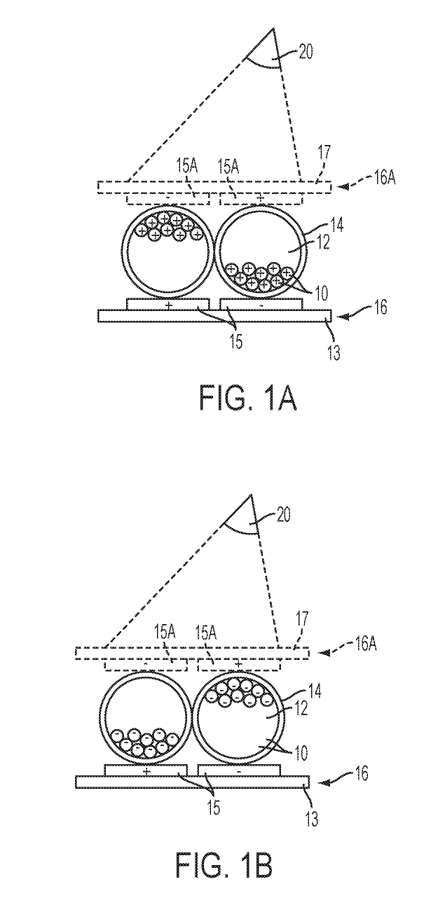

Charged fluorescent dendrimers may be used as charged particles to provide visible colors in both flexible and non-flexible display technologies, and provide improved hue, brightness, and color intensity as compared to non-fluorescent pigments and dyes. In addition, the fluorescent dyes covalently bound to a dendrimer may provide improved color-fastness and photostability as compared to non-polymer bound pigments and dyes. Non-fluorescent pigments can simply reflect light at a particular wavelength or wavelengths, while fluorescent dendrimers may emit light at a particular wavelength or wavelengths, thereby providing brighter colors for displays such as electrophoretic displays. Electrophoretic displays incorporating such charged particles, for example as illustrated in FIGS. 1A-1C, may be used in a variety of devices, such as cellular telephones, e-book readers, tablet computers, portable computers, smart cards, signs, watches, or shelf labels, to name a few examples.

Electrophoretic displays may include charged fluorescent particles 10, depicted in FIGS. 1A-1C, for providing color to the display. The particles 10 may include fluorophores covalently bonded to a dendrimer core. The particles 10 may be nanoparticles, microparticles, nanospheres, or microspheres, may have a size from about 1 nanometer to about 20 nanometers, and will, for simplification, be generally referred to as microparticles herein. A fluorophore may be any molecular moiety which emits a visible color upon excitation with radiation of an appropriate wavelength.

At least one charged microparticle 10 may be encapsulated along with a suspension fluid 12 within at least one microcapsule 14. Alternatively, a plurality of the microparticles 10 may be present in each microcapsule 14. The suspension fluid 12 may be a dielectric solvent having a density that allows the microparticles to be suspended in the solvent, for movement within the solvent when an electric charge is applied to attract or repel the microparticles. In an embodiment, the density of the solvent may be approximately the same as the density of the microparticles 10. To allow for high particle mobility, the solvent or solvent mixture in the suspension fluid 12 in which the fluorescent particles are dispersed may have a low viscosity and a dielectric constant of about 2 to about 50. For example, the fluid may have a kinematic viscosity of about 0.2 centistokes to about 50 centistokes. Specific examples of kinematic viscosity include about 0.2, about 0.4, about 0.6, about 0.8, about 1, about 2, about 4 about 6, about 8, about 10, about 15, about 20, about 25, about 30, about 35, about 40, about 45, about 50, and any values or ranges between an of the listed values. In addition, the dielectric constant may be about 2 to about 50, about 2 to about 25, about 2 to about 20, or about 2 to about 15. Specific examples of dielectric constants include about 2, about 5, about 10, about 15, about 20, about 25, about 30, about 35, about 40, about 45, about 50, and ranges between any two of these values (including endpoints).

The solvent, or two or more solvents for the suspension fluid 12 may be selected such that the fluorescent microparticles are insoluble in the solvent, the long term chemical and structural stabilities of the fluorescent microparticles are maintained, and the solvent counteracts fluorescent quenching and aggregation of the fluorescent microparticles. The solvent or solvents of suspension fluid 12 may be linear or branched hydrocarbon oil, halogenated hydrocarbon oil, silicone oil, water, decane epoxide, dodecane epoxide, cyclohexyl vinyl ether, naphthalene, tetrafluorodibromoethylene, tetrachloroethylene, trifluorochloroethylene, 1,2,4-trichlorobenzene, carbon tetrachloride, decane, dodecane, tetradecane, xylene, toluene, hexane, cyclohexane, benzene, an aliphatic hydrocarbon, naphtha, octamethyl cyclosiloxane, cyclic siloxanes, poly(methyl phenyl siloxane), hexamethyldisiloxane, polydimethylsiloxane, poly(chlorotrifluoroethylene) polymer, or combinations of any two or more of these.

Some additional examples of suitable dielectric solvents may include hydrocarbons such as isopar, decahydronaphthalene (DECALIN), 5-ethylidene-2-norbornene, fatty oils, paraffin oil; silicon fluids; aromatic hydrocarbons such as phenylxylylethane, dodecylbenzene and alkylnaphthalene; halogenated solvents such as perfluorodecalin, perfluorotoluene, perfluoroxylene, dichlorobenzotrifluoride, 3,4,5-trichlorobenzotrifluoride, chloropentafluoro-benzene, dichlorononane, pentachlorobenzene; and perfluorinated solvents such as FC-43, FC-70 and FC-5060 from 3M Company, St. Paul Minn., low molecular weight halogen containing polymers such as poly(perfluoropropylene oxide) from TCI America, Portland, Oreg., poly(chlorotrifluoro-ethylene) such as Halocarbon Oils from Halocarbon Product Corp., River Edge, N.J., perfluoropolyalkylether such as Galden from Ausimont or Krytox Oils and Greases K-Fluid Series from DuPont, Del., polydimethylsiloxane based silicone oil from Dow-Corning (DC-200). The solvent or solvent mixture may be visibly transparent, and, in addition, the solvent may be visibly colorless, or, alternatively, may be colored by a dye or pigment.

The microcapsules 14 may be formed of polymers and may be visually transparent for viewing of the contents therein. Additional types of micro-container units, or display cells, may be used in place of microcapsules 14. Micro-container units, or display cells, may include any type of separation units which may be individually filled with a display fluid. Some additional examples of such micro-container units may include, but are not limited to, micro-cups, micro-channels, other partition-typed display cells and equivalents thereof.

In an embodiment, the microcapsules 14 may be disposed adjacent to at least a first electrode layer 16 configured for applying a positive or negative charge adjacent to a side of the microcapsules. The first electrode layer 16 may be a conducting film, and may be flexible to allow for flexible displays. The first electrode layer 16 may have a base substrate 13 supporting individual electrodes 15 corresponding to each microcapsule 14

With a configuration as shown in FIG. 1A, wherein the microparticles 10 have a positive charge, an application of a positive charge to the first electrode layer 16 adjacent to a microcapsule 14 may repel the microparticles away from the electrode, while an application of a negative charge to the first electrode layer adjacent to a microcapsule may attract the microparticles to the electrode. In this manner, if the suspension fluid 12 is of a first color, and the charged microparticles 10 are of a second color, the side of the microcapsules 14 (upper side in FIG. 1A) disposed away from the first electrode layer 16 will appear to a viewer 20 to have the color of the suspension fluid (right-side microcapsule in FIG. 1A) when the microparticles are attracted to the first electrode layer. On the other hand, the upper side of the microcapsules 14 will visually appear to have the color of the microparticles 10 (left-side microcapsule in FIG. 1A) when the microparticles are repelled away from the first electrode layer 16.

In an alternative embodiment, instead of just one electrode layer 16, the display may also have a second electrode layer 16A (shown in dotted lines in FIGS. 1A and 1B) of appropriate conducting material, and spaced apart from, and opposite to the first electrode layer 16. At least one face 17 may be formed as a transparent conducting material which may also act as a substrate material for the individual electrodes 15A which may be disposed on an inner surface of the second electrode layer 16A towards the first electrode layer 16. The microcapsules 14 may be sandwiched between the first electrode layer 16 and the second electrode layer 16A. Some examples of transparent conducting materials may include, but are not limited to, indium tin oxide (ITO) on polyester, aluminum zinc oxide (AZO), fluorine tin oxide (FTO), poly(3,4-ethylenedioxythiophene) (PEDOT), PEDOT with poly(styrene sulfonate) (PSS), poly(4,4-dioctylcyclopentadithiophene), and carbon nanotubes. A voltage difference may be imposed across the microcapsules 14 wherein one electrode layer may apply a charge which is opposite to the charge of the other electrode layer. In this manner, one side of the arrangement may attract the microparticles 10 while the other side repels the microparticles 10 to better facilitate movement of the microparticles through the suspension fluid 12.

The colors produced at the surface of face 17 of such electrophoretic displays may be promoted and/or enhanced by direct sunlight, other external lighting sources, or back-lighting.

As an alternative, as depicted in FIG. 1B, the visible color in microcapsules 14 may be produced by providing two sets of oppositely charged microparticles 10 in each microcapsule 14, wherein each set of microparticles 10 fluoresces a different color. For example, the positively charged particles may fluoresce red and the negatively charged particles may fluoresce yellow (or any other color combinations). Application of electric fields as shown, would attract the red-fluorescing (positive) particles to the negatively charged electrodes and the yellow fluorescing (negative) particles to the positively charged electrodes, and in the depiction of FIG. 1B, the upper surface in the left microcapsule would appear red, and the upper surface in the right microcapsule would appear yellow.

An electrophoretic display may be assembled as follows. A substrate having thin film transistor (TFT) elements may be coated with a photoresist layer by coating a resist material on the TFT glass substrate. Grooves arranged in an intended partition pattern may be formed in the photoresist layer by photolithography. The grooves may be supplied with a two-part curable silicone resin and the resin may be cured. Thereafter, the resulting photoresist layer may be exfoliated and removed from the substrate, whereby partitions formed of the silicone resin extending upward from the substrate may be formed. In an embodiment, an electrophoretic dispersion may be filled directly into the corresponding spaces defined by the partitions (cell spaces) using an ink-jet device, or as discussed above, microcapsules may be filled with the microparticles dispersion and the microcapsules may be introduced onto the substrate layer. A glass substrate with an ITO layer on an entire surface thereof may be placed over the cell spaces, and the periphery portion of the paired substrates may be sealed with an epoxy resin to produce an electrophoretic display device. The terminal section of the resulting electrophoretic display device may be coupled with a power source through lines to activate the device.

The microparticles 10 that are used in electrophoretic displays may be chosen, or configured, based on the desired colors required for the display. While black and white colors would be used, for example, in e-book readers which display a replica of a white page with black type, alternative particles that fluoresce additional individual colors may also be used. To provide color combinations, the microcapsules 14 of an array of microcapsules may individually be filled with microparticles that fluoresce different colors in a repeating pattern so that by activating selected ones of the microcapsules, individual colors, and color combinations may be achieved. Two common models for obtaining various colors and color combinations include the RYB or red-yellow-blue model which uses the named set of subtractive primary colors, or the RGB or red-green-blue model which uses the named set of additive primary colors.

As an example, in an RYB system, individual microcapsules may be provided containing the individual microparticles that fluoresce red, yellow, or blue, and the microcapsules may be arranged in a repeating array of the three colors. When a red-color is desired to be displayed, a negative charge may be selectively applied to the microcapsules containing the microparticles that fluoresce red, or alternatively, for yellow, a negative charge may be selectively applied to the microcapsules that fluoresce yellow. To produce orange, however, a negative charge may be selectively applied to the microcapsules containing red-fluorescing particles and to the microcapsules containing yellow fluorescing particles, so that the red fluorescence and yellow fluorescence combine to produce an orange color. This could be applied to any combination of microcapsules to produce a variety of colors.

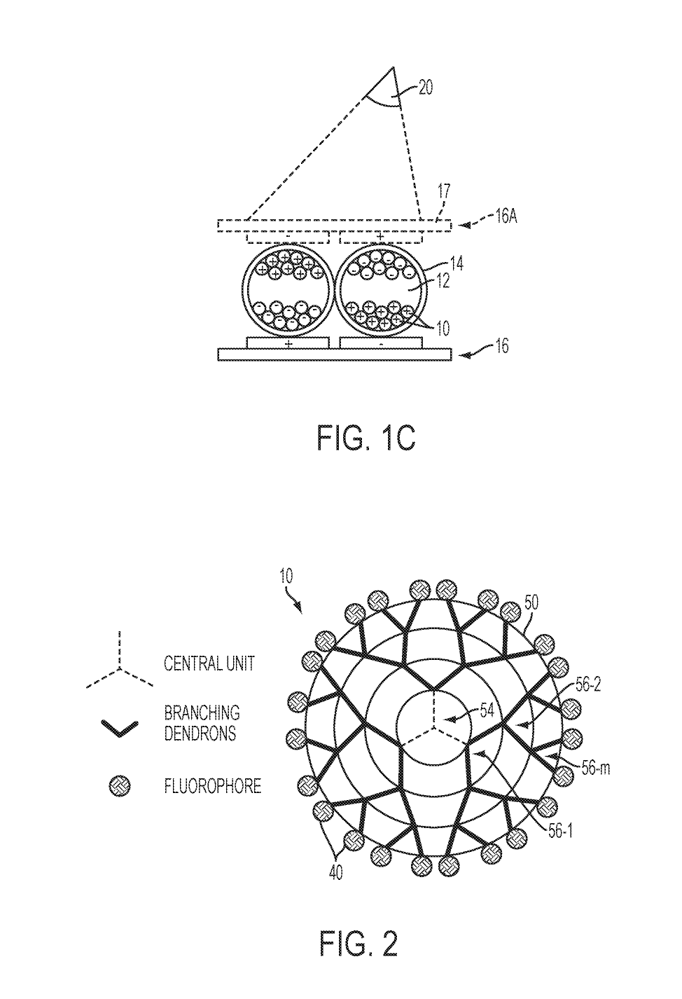

As mentioned above, and as represented in a simplified embodiment depicted FIG. 2, each microparticle 10 may be a charged particle including fluorophores 40 bonded to a dendrimer core 50. The dendrimer core 50 may have a central ‘starting’ unit 54 as well as several generations of branching dendrons 56-1, 56-2, 56-m. The charge of the microparticles 10 may be provided by the fluorophores 40, the dendrimer molecules, or both, wherein anionic dendrimers or fluorophores may provide negatively charged particles, or cationic dendrimers or fluorophores may provide positively charged particles.

The fluorophore may be a derivative of a fluorophore molecule having at least one reactive functional group, and the dendrimer core may be a derivative of a dendrimer molecule having at least one surface reactive functional group. The fluorophore molecule and the dendrimer molecule may be selected or configured so that the at least one surface reactive functional groups of the dendrimer molecule may react with the at least one reactive functional group of the fluorophore molecule to covalently link the dendrimer molecule with the fluorophore molecule.

In an embodiment, one of the reactive functional groups and the surface reactive functional groups may be an amine-reactive carbonyl group, and the other one of the reactive functional groups and the surface reactive functional groups may be a surface reactive amine. In various embodiments, the amine-reactive carbonyl group may be an aldehyde, a ketone, a carboxylic acid, an ester, an acyl halide, an anhydride, or any combination thereof.

Dendrimer cores 50 having m-generations of branching dendrons may be synthesized by reiterative substitution reactions that build outwardly one generation upon another. The branching dendrons 56-1, 56-2, 56-m may have the surface reactive functional groups as a part of the molecular structure of the dendrons, or alternatively, upon establishing the desired number of generations, a portion of the branching dendrons may be modified to include the surface reactive functional groups.

Similarly, fluorescent dyes may be chosen which already have the reactive functional groups as a part of the structure of the fluorophore molecules, or alternatively, fluorophore molecules may be modified to include the reactive functional groups.

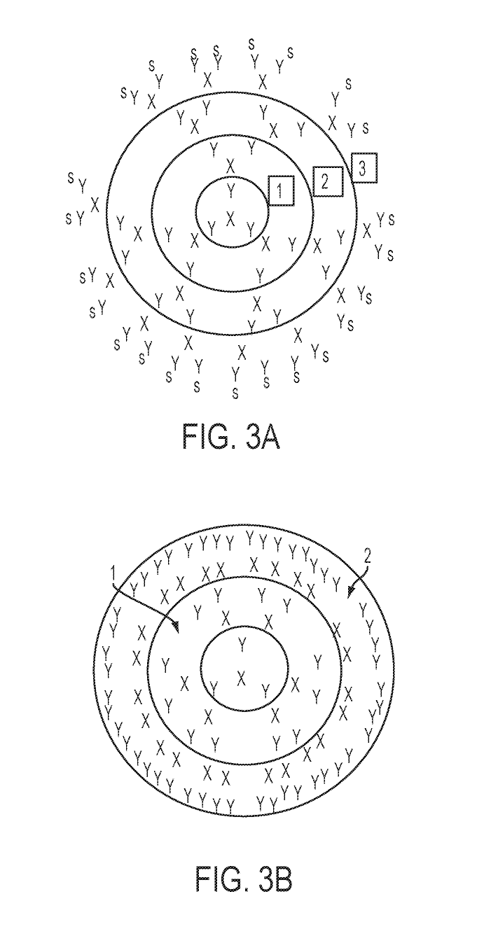

FIGS. 3A and 3B depict non-limiting example of a dendrimer molecule represented in a 2-dimensional plane. A typical dendrimer may however be 3-dimensional and take on a spherical configuration. A central core may have a representative structure (X-Yₙ) with each X bound to n units of Y, which as represented in FIGS. 3A and 3B corresponds to (X-Y₃) or each X binding to 3 units of Y. The dendrimer molecule may have a branching repeating structure of at least (m) generations of repeating units, which as represented in FIG. 3A corresponds to 3 generations. The repeating units may have a representative structure (X-Yₙ₋₁) with each X bound to (n−1) units of Y, which as represented in FIGS. 3A and 3B corresponds to (X-Y₂) with each X binding to 2 units of Y. The units Y in the m^{th} generation (3^{rd} generation in FIG. 3A, not represented in FIG. 3B) of the repeating units may have at least one surface reactive functional groups (−s). For simplicity, additional generations of repeating units are not shown.

As represented in FIG. 3A, each Y may have 2 binding sites for an X, whereby the dendrimer growth branches at an X component that has 3 binding sites for a Y. As such, each generation has twice as many of each of the X and Y components as the previous generation (generation 1 has 3-X and 6-Y; generation 2 has 6-X and 12-Y; generation 3 has 12-X and 24-Y; etc.) As an alternative as represented in FIG. 3B, each Y may have 3 binding sites for an X, whereby the dendrimer growth may then branch at both the X component and the Y component (generation 1 has 6-X and 12-Y; generation 2 has 24-X and 48-Y; generation 3 (not shown) would have 96-X and 192-Y; etc.). In various embodiments, the X and the Y components may each have two or more binding sites for the other of the X and Y components. If both X and Y have only two binding sites for the other of the X and Y, essentially linear growth would occur.

In an embodiment, the dendrimer molecules used for the electrophoretic particles 10 may have up to about 10 generations of repeating units. As examples, the dendrimer molecules may have 1 generation, 2 generations, 3 generations, 4 generations, 5 generations, 6 generations, 7 generations, 8 generations, 9 generations, or 10 generations. For larger sized particles additional generations may be added.

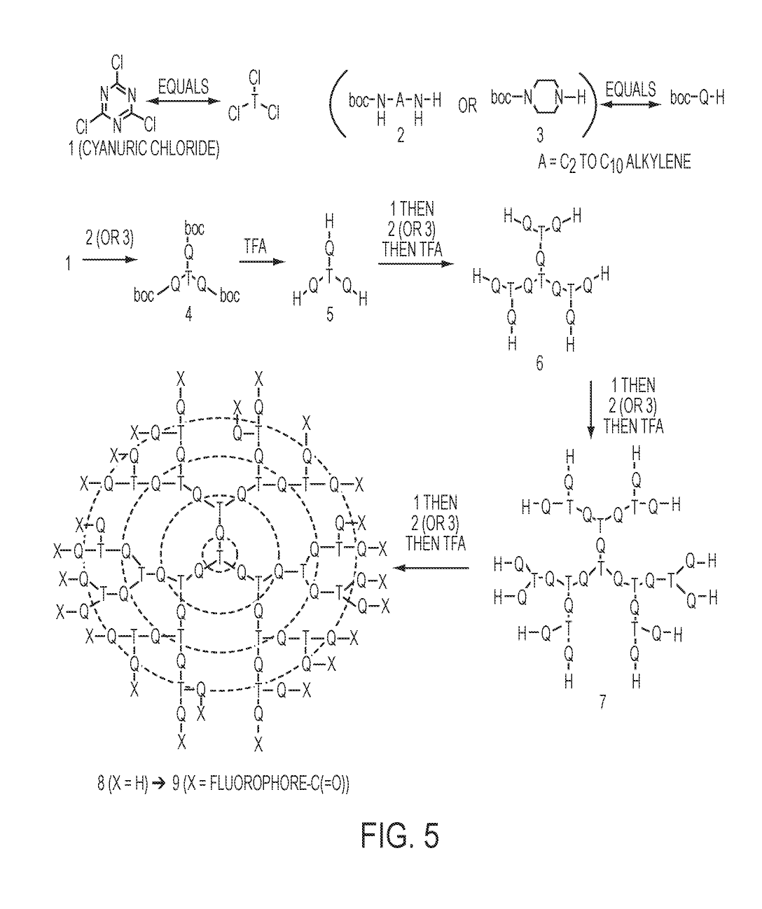

In embodiments as discussed below, the fluorophore may be a derivative of a fluorophore molecule having at least one amine-reactive carbonyl group, and the dendrimer core may be a derivative of a dendrimer molecule having at least one surface reactive amine Two examples of dendrimer molecules having surface reactive amines, as represented schematically by FIGS. 3A and 3B, may be dendrimers wherein the X component is derived from 1,3,5 triazine (cyanuric chloride or 2,4,6-trichloro-1,3,5-triazine, shown in FIG. 5 and discussed further herebelow). A dendrimer as in FIG. 3A may have a Y component that is derived from a component that has terminal diaminyl groups. While not limited to the following, some examples of terminal diaminyl groups include

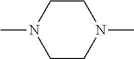

and —NH-A-NH— wherein A is C₂ to C₁₀ alkylene. Additional examples of diamine components may include aminomethylpiperidine, aminopiperidine, aminopyrrolidine, aminoalkylpiperidine, aminoalkylpyrrolidine. A dendrimer as in FIG. 3B may have a Y component that is derived from a triamine. While not limited to the following, some examples of triamine components may include diaminodipropylamine and diaminodialkylamine,

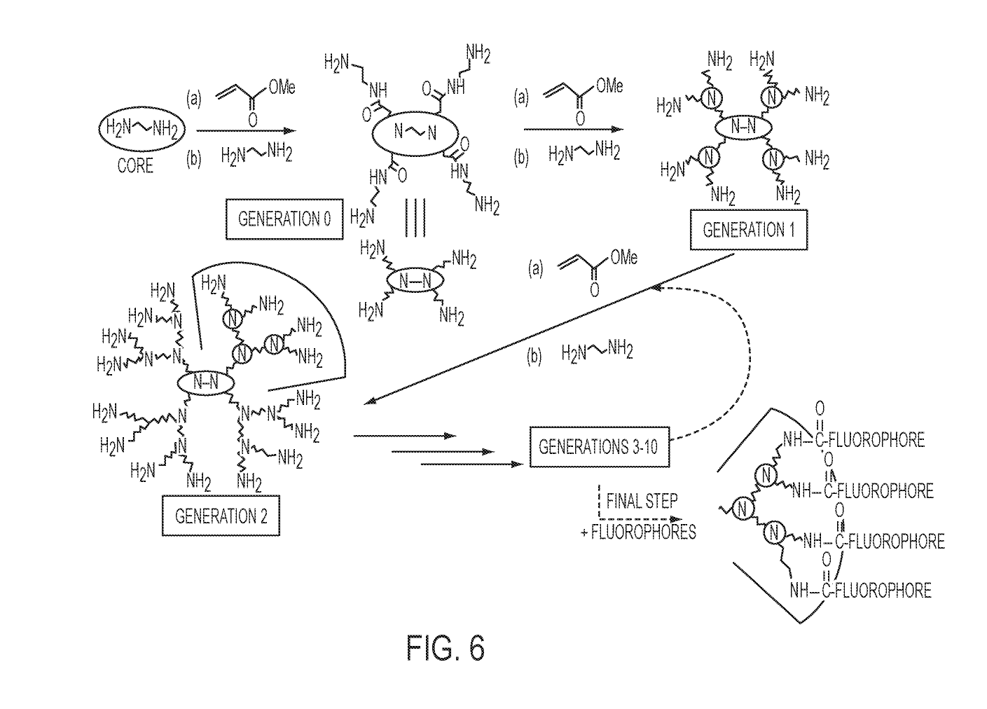

While not limited to the following, some additional examples of chemical moieties from which the X component may be derived include diamines, such as ethylenediamine (shown in FIG. 6 and discussed further herebelow), and 1,4 diaminobenzene.

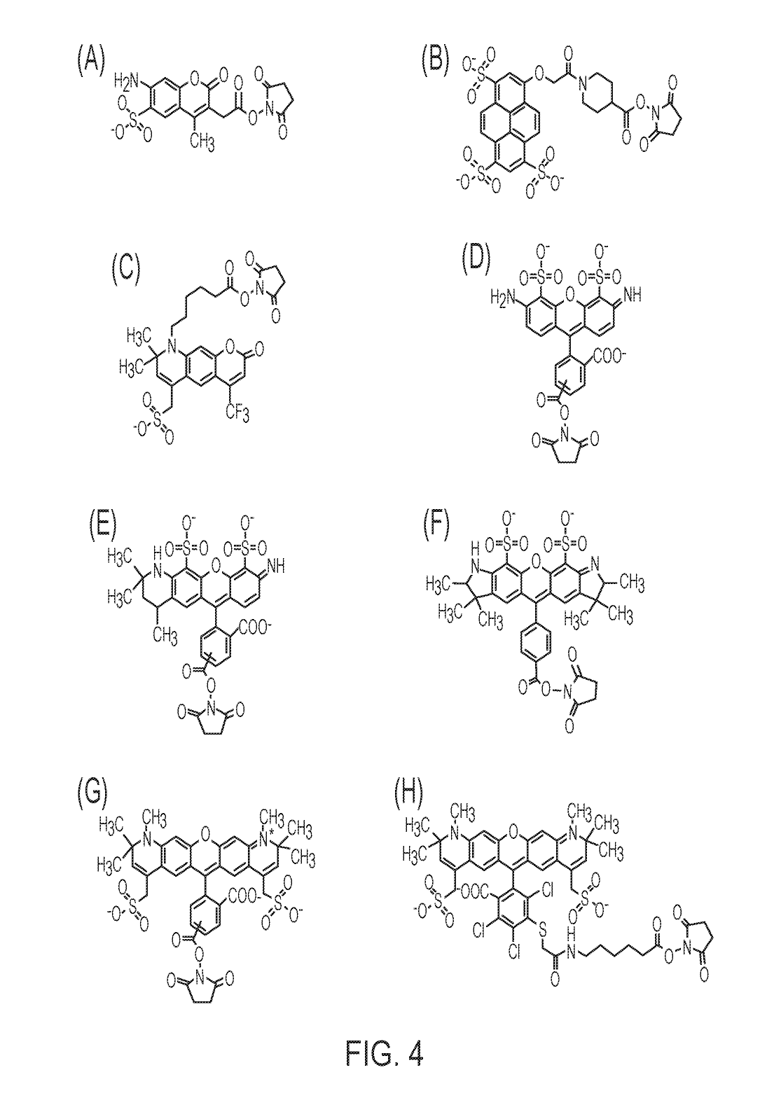

Amine-reactive fluorophores may include dyes having an activated N-hydroxysuccinimide (NHS) ester group as the amine reactive carbonyl group. Some examples of such dyes include the NHS esters of the photostable Alexa Fluor® fluorescent dyes (from Molecular Probes, Inc., Eugene, Oreg.) as listed below in Table 1 with their corresponding emission colors, and the structures of which are correspondingly presented in FIG. 4. The amine-reactive fluorophores such as those listed in Table 1 below, may be excited with visible light to emit the various colored electromagnetic radiation or fluorescence.

TABLE 1

| | Excitation | Emission | |
|---|---|---|---|
| Fluorescent dye | (nm) | (nm) | Emission color |
| (A) Alexa Fluor ® 350 SE | 346 | 442 | Blue |
| (B) Alexa Fluor ® 405 SE | 402 | 421 | Blue |
| (C) Alexa Fluor ® 430 SE | 434 | 539 | Yellow-green |
| (D) Alexa Fluor ® 488 SE | 495 | 519 | Green |
| (E) Alexa Fluor ® 514 SE | 518 | 540 | Green |
| (F) Alexa Fluor ® 532 SE | 531 | 554 | Yellow |
| (G) Alexa Fluor ® 594 SE | 590 | 617 | Red |
| (H) Alexa Fluor ® 610 SE | 612 | 628 | Red |

As illustrated in the representative structures in FIG. 4, the Alexa Fluor® dyes carry a negative charge and therefore when covalently bound to a dendrimer may provide an anionic fluorescent dendrimer.

Additional examples of dyes that may also be usable include amine reactive anionic fluorescent dyes such as 5-carboxyfluorescein succinimidyl ester (excitation 492 nm, emission 518 nm, green), 6-carboxyfluorescein succinimidyl ester (excitation 492 nm, emission 515 nm, green), and Chromis 645 XT A —NHS ester (excitation 648 nm, emission 667 nm, green).

In an embodiment, charged fluorescent particles may be configured to emit blue-colored electromagnetic radiation. The charged fluorescent particles may have a core dendrimer with either one, or possibly both of the Alexa Fluor® dyes (A) and (B) covalently bonded to amine nitrogens of the dendrimer via a —(C═O)— of the dye molecules.

In an embodiment, charged fluorescent particles may be configured to emit yellow-green-colored electromagnetic radiation. The charged fluorescent particles may have a core dendrimer with the Alexa Fluor® dye (C) covalently bonded to amine nitrogens of the dendrimer via a —(C═O)— of the dye molecules.

In an embodiment, charged fluorescent particles may be configured to emit green-colored electromagnetic radiation. The charged fluorescent particles may have a core dendrimer with either one, or possibly both of the Alexa Fluor® dyes (D) and (E) covalently bonded to amine nitrogens of the dendrimer via a —(C═O)— of the dye molecules.

In an embodiment, charged fluorescent particles may be configured to emit yellow-colored electromagnetic radiation. The charged fluorescent particles may have a core dendrimer with the Alexa Fluor® dye (F) covalently bonded to amine nitrogens of the dendrimer via a —(C═O)— of the dye molecules.

In an embodiment, charged fluorescent particles may be configured to emit red-colored electromagnetic radiation. The charged fluorescent particles may have a core dendrimer with either one, or possibly both of the Alexa Fluor® dyes (G) and (H) covalently bonded to amine nitrogens of the dendrimer via a —(C═O)— of the dye molecules.

Charged fluorescent particles may be produced by contacting fluorophores with dendrimers, wherein the fluorophores comprise at least one amine-reactive carbonyl group selected from the group comprising: aldehyde, ketone, carboxylic acid, ester, acyl halide, anhydride, and combinations thereof, and the dendrimers include at least one surface reactive amine. By selecting or configuring the fluorophores and dendrimers with such reactive groups, the at least one surface reactive amines may react with the at least one amine-reactive carbonyl group to covalently bond the dendrimer molecules with the fluorophores.

As represented in FIGS. 5 and 6, and discussed in more detail further below, a dendrimer molecule may be formed by providing a core unit and adding a first generation of branched molecular units to the core unit. Additional generations of branched molecular units may be added to a previous generation of branched molecular units to produce an m^{th} generation dendrimer having m generations of the branched molecular units. When the dendrimer molecule is of a desired size, or has a specified number of generations, fluorophores may be covalently bonded to the m^{th} generation of molecular units to produce a charged fluorescent dendrimer.

In an embodiment as depicted in FIG. 5, the core molecule may be cyanuric chloride and the method may include producing a 0^{th} generation dendrimer by reacting the cyanuric chloride with a mono-protected diamine to replace chlorine moieties of the cyanuric chloride with the diamine, and deprotecting the diamine to produce the 0^{th} generation dendrimer.

Additional generations may then be added to the 0^{th} generation dendrimer by reacting the 0^{th} generation dendrimer with cyanuric chloride to bond the cyanuric chloride to each diamine. The cyanuric chloride bonded to the diamine may be reacted with additional mono-protected diamine to replace chlorine moieties of the cyanuric chloride. The diamine may be deprotected to produce an additional generation of the dendrimer. For each additional generation desired, the above steps may be repeated. The outermost, or m^{th} generation applied may have free-reactive amines available for reacting with the fluorophores, and the amine surface groups may be subsequently reacted with an amine reactive charged fluorophore to produce charged fluorescent dendrimer particles.

To produce a 0^{th} generation dendrimer, a first solution of mono-protected diamine, diisopropylethylamine, and a solvent may be cooled to less than about 5° C. A second solution of cyanuric chloride in a solvent may be added dropwise to the first solution to produce a third solution, and the third solution may be heated to and maintained at at least about 50° C. for a period of time sufficient for reaction between the cyanuric chloride and the diamine to produce protected dendrimers in a first mixture. The mixture may be cooled to about room temperature and filtered to remove any undissolved/unreacted particulates. Protected dendrimer may be precipitated by treating the first mixture with diethyl ether, and the protected dendrimers may be filtered from solution. The protected dendrimer may be treated to deblock the dendrimer and produce the 0^{th} generation dendrimer.

The additional generations may then be added by making a fourth solution of the dendrimer, diisopropylethylamine, and a solvent, and cooling the fourth solution to about 5° C. A solution of cyanuric chloride in a solvent may be added dropwise to the fourth solution to produce a fifth solution and the fifth solution may be stirred for a period of time sufficient for bonding of the cyanuric chloride to the dendrimer. This fifth solution may be mixed with a sixth solution of the mono-protected diamine, diisopropylethylamine and a solvent to produce a seventh solution. The seventh solution may be heated to and maintained at least about 50° C. to react the cyanuric chloride to the additional mono-protected diamine to produce a next generation protected dendrimer in a second mixture. As was done above for the first mixture, the second mixture may then be cooled to about room temperature, filtered, and treated with diethyl ether to precipitate the next generation protected dendrimer. The next generation protected dendrimer may then be treated to deblock the dendrimer and produce the additional generation.

In an alternative embodiment, as depicted in FIG. 6, poly(amidoamine) (PAMAM) dendrimers may also be used for producing charged fluorescent dendrimers. PAMAM dendrimers may have a diamine core, such as ethylene diamine as shown or another diamine, and may be constructed by a reiterative reaction sequence beginning with treatment of the diamine core with methyl acrylate (a) followed by treatment with an additional diamine, that may again be ethylene diamine (b) as shown or another diamine. Additional generations may be formed by repeating treatments with methyl acrylate and the diamine. In the final generation, the amine surface groups may be subsequently reacted with an amine reactive charged fluorophore to produce charged fluorescent dendrimer particles. As an alternative to producing such dendrimers, generation 0 to generation 10 PAMAM dendrimers having amine surface groups are available from Dendritech (Midland, Mich.).

Charged fluorescent dendrimers, such as, for example, any of the embodiments as discussed above, may be produced and marketed in a final dendrimer form. Alternatively, the components for producing the charged fluorescent dendrimers could be sold in kit form to allow an end user to produce the dendrimers on site, for example, and possibly on an ‘as-needed’ basis. Such a kit may be for producing microparticles that emit only one color, and may include the fluorophores that emit the color, as well as the dendrimers to which the fluorophores will be bonded to form the charged fluorescent dendrimers. As an alternative, instead of containing the completed dendrimer core to which the fluorophores will be attached, the kit may include the components needed for constructing the dendrimer core, thereby giving the end-user the ability to alter the size of the dendrimers on site. In an embodiment, a kit may be configured for producing a first batch of microparticles that emit one color as well as a second batch of microparticles that emit another color, or any combination of two or more batches of microparticles that emit particular colors.

Such a kit, for example, may include fluorophores with a reactive functional group and dendrimers with a surface reactive functional group, wherein the reactive functional groups of the fluorophores and the surface reactive functional group of the dendrimers are configured to react and covalently bond the fluorophores to the dendrimer. The fluorophores and dendrimers may be any of the components as previously discussed.

As a non-limiting example, for particles that emit blue color, the kit may include fluorophores A and/or B of FIG. 4, and dendrimers 9 in FIG. 5 with surface reactive amines.

As a non-limiting example, for particles that emit yellow-green color, the kit may include fluorophores C of FIG. 4, and dendrimers 9 in FIG. 5 with surface reactive amines.

As a non-limiting example, for particles that emit green color, the kit may include fluorophores D and/or E of FIG. 4, and dendrimers 9 in FIG. 5 with surface reactive amines.

As a non-limiting example, for particles that emit yellow color, the kit may include fluorophores F of FIG. 4, and dendrimers 9 in FIG. 5 with surface reactive amines.

As a non-limiting example, for particles that emit red color, the kit may include fluorophores G and/or H of FIG. 4, and dendrimers 9 in FIG. 5 with surface reactive amines.

A kit may include any combination of, or all of the components for producing any combination of, or all of the red light-emitting microparticles, the blue light-emitting microparticles, green light-emitting microparticles, the yellow-green light-emitting microparticles, or the yellow light-emitting microparticles. In an additional embodiment, a kit may also be configured as a kit for producing an electrophoretic medium and may include a suitable solvent in addition to components for producing the microparticles, or alternatively the completed microparticles. The solvent may be a single-component solvent or solvent mixture selected from the solvent list as previously provided. In a further embodiment, a kit may also be configured as a kit for producing microcapsules filled with an electrophoretic medium. Such a kit may include components for producing the microparticles or the completed microparticles, a suitable solvent, and also micro-container components for containing the electrophoretic medium. The micro-container units may be microcapsules or other micro-container units selected from the examples as previously provided. In another embodiment, a kit may also be configured as a kit for producing an electrophoretic display. As such, the kit may include components for producing the microparticles or the completed microparticles, a suitable solvent, micro-container units, and electrode layers. The electrode layers may be selected from the examples as previously provided.

### EXAMPLES

### Example 1

### Production of Charged Fluorescent Dendrimers Capable of Emitting Red-Colored Light

As illustrated in FIG. 5, core dendrimers are synthesized by reiterative substitution reactions between cyanuric chloride 1 (a triazine derivative), and mono-Boc-protected diamine 2 or 3 followed by Boc-deprotection.

In a first iteration, a solution of the triazine 1 (about 1 equivalent) in a suitable solvent such as tetrahydrofuran (THF) is added drop-wise to an ice cold mixture of diamine 2 or 3 (about 3 equivalents), diisopropylethylamine (about 3 equivalents) and a suitable solvent such as THF. After about 1 hour, the mixture is heated slowly to about 70° C. and maintained at about 70° C. for about 6 hours. The mixture is cooled to room temperature, filtered to remove diisopropylethylamine hydrochloride and then treated with diethyl ether to precipitate the tris-Boc-protected triamino-triazine 4. The tris-Boc-protected triamino-triazine 4 is filtered and treated with trifluoroacetic acid (TFA) in dichloroethane to deblock the Boc protective groups providing triamino-triazine 5.

An additional generation is then added by starting with a drop-wise addition of a solution of triazine 1 (about 3 equivalents) in THF to an ice cold mixture of 5 (about 1 equivalent), diisopropylethylamine (about 3 equivalents) and THF. After stirring in an ice bath for about 1 hour, the mixture is treated with a mixture of diamine 2 or 3 (about 6 equivalents), diisopropylethylamine and THF and then heated slowly to about 70° C. and maintained at about 70° C. for about 6 hours. The mixture is cooled to room temperature, filtered, and treated with diethyl ether. The precipitate is treated with TFA and dichloroethane to provide hexamine 6.

Additional generations may be added by repeating the above steps with appropriate proportions of reagents, until a desired number of generations are added. For example, component 7 is obtained from 6, and component 8 is obtained from 7.

In a final set of steps, the charged fluorescent dendrimers are synthesized by mixing dendrimer 8 and the carboxylic-reactive Alexa Fluor NHS ester (G) (about 1 equivalent per equivalent of free primary amino group present in 8) in a dry polar aprotic solvent such as DMSO or N-methylpyrrolidinone (NMP). The mixture is stirred at room temperature or heated to about 60° C. overnight. The mixture is treated with a suitable solvent, such as toluene, to precipitate the dendrimer 9. Anionic fluorescent dendrimer 9 that is capable of emitting red-colored light is filtered from solution and washed.

### Example 2

### A Kit for Producing Charged Fluorescent Dendrimers

A kit is configured for producing colors for an RGB output device. The kit includes components for producing each of: dendrimers that emit red-colored light, dendrimers that emit green-colored light, and dendrimers that emit blue-colored light. For each of the three fluorescent dendrimers, the kit includes core dendrimers 8 as produced in Example 1. For the red-light emitting dendrimers, the kit includes Alexa Fluor® dye (E). For the green-light emitting dendrimers, the kit includes Alexa Fluor® dye (D). For the blue-light emitting dendrimers, the kit includes Alexa Fluor® dye (A).

### Example 3

### An Electrophoretic Medium

An electrophoretic medium for use in electrophoretic displays includes any of the fluorescent dendrimers produced, for example, from the kit of Example 2, and according to the final steps in the procedure of Example 1. An electrophoretic medium having about 1 volume % to about 30 volume % charged dendrimers for producing a red color in an electrophoretic display is made by dispersing the red-fluorescing dendrimers of Example 1 in a hydrocarbon oil. Similarly, for any additional color desired, an electrophoretic medium having about 1 volume % to about 30 volume % charged dendrimers for producing the desired color may be made by dispersing the appropriate fluorescing dendrimers in a hydrocarbon oil.

### Example 4

### An Electrophoretic Display

Each individual electrophoretic medium of Example 3 is encapsulated within individual urea/melamine/formaldehyde microcapsules of about 50 micrometer diameter. The microcapsules are dispersed in a regular repeating pattern of colors, red-green-blue-red-green-blue, etc., on a conductive plates of indium tin oxide (ITO) on polyester, and the plate is connected to electrical circuitry that allows external signals to manipulate the electric charge at different precise points on the plate corresponding to individual microcapsules.

### Example 5

### A Dual Layer Electrophoretic Display

Each individual electrophoretic medium of Example 3 is encapsulated within individual urea/melamine/formaldehyde microcapsules of about 50 micrometer diameter. The microcapsules are dispersed in a regular repeating pattern of colors, red-green-blue-red-green-blue, etc. between two parallel conductive plates of indium tin oxide (ITO) on polyester, spaced about 50 micrometers apart, and the plates are connected to electrical circuitry that allows external signals to manipulate the electric charge at different precise points on the plates corresponding to individual microcapsules.

### Example 6

### Method of Using an Electrophoretic Display

An electrophoretic display as produced in Example 5 having red, green and blue fluorescing microcapsules will be provided as a color display in a cell-phone with the second electrode plate on top for viewing. An additional illuminating plate will be provided over the second electrode plate to expose the microcapsules to fluorescent light of a wavelength of about 350 nm to about 650 nm.

Since the microparticles are negatively charged, to activate the microcapsules a positive charge will be applied to the second plate adjacent the desired microcapsules to be activated, while a negative charge will be applied to the first plate. The microparticles in the activated microcapsules will then move towards the second plate to visibly fluoresce color at the second plate for viewing. To remove the colors from viewing, the charges will be reversed at the plates to withdraw the microparticles away from the second plate. As an example: to produce red in a portion of the display, individual microspheres containing red-fluorescing microparticles will be activated; to change the viewable color from red to green in that portion of the display, the red-fluorescing microspheres will be de-activated and the individual microspheres containing green-fluorescing microparticles will be activated; and to subsequently produce yellow in that same portion of the display, the microspheres containing the red-fluorescing microparticles will again be activated so that both red and green colors will be fluoresced to produce yellow.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, components, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” or “comprises” or “comprise” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases one or more or at least one and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. An electrophoretic display comprising:
at least one first electrode layer configured to selectively apply an electric field; and
an electrophoretic medium disposed adjacent to the at least one first electrode layer, wherein the electrophoretic medium comprises:
a fluid having a first color; and
at least one electrically charged particle disposed in the fluid, wherein the at least one electrically charged particle is configured to move in the fluid when the electrical field is applied,
wherein the at least one charged particle comprises a charged fluorescent dendrimer configured to emit a second color different from the first color of the fluid.

2. The electrophoretic display of claim 1, wherein the electrophoretic medium is contained in at least one microcapsule.

3. The electrophoretic display of claim 1, wherein the at least one charged particle has a cross-sectional dimension of about 1 nanometer to about 20 nanometers.

4.-6. (canceled)

7. The electrophoretic display of claim 1, wherein the fluid comprises at least one of: linear hydrocarbon oil, branched hydrocarbon oil, halogenated hydrocarbon oil, silicone oil, water, decane epoxide, dodecane epoxide, cyclohexyl vinyl ether, naphthalene, tetrafluorodibromoethylene, tetrachloroethylene, trifluorochloroethylene, 1,2,4-trichlorobenzene, carbon tetrachloride, decane, dodecane, tetradecane, xylene, toluene, hexane, cyclohexane, benzene, an aliphatic hydrocarbon, naphtha, octamethyl cyclosiloxane, cyclic siloxanes, poly(methyl phenyl siloxane), hexamethyldisiloxane, polydimethylsiloxane, and poly(chlorotrifluoroethylene) polymer.

8. The electrophoretic display of claim 1, wherein the charged fluorescent dendrimer comprises at least one charged fluorophore covalently bonded to a dendrimer core.

9. (canceled)

10. The electrophoretic display of claim 1, wherein the charged fluorescent dendrimer comprises anionic fluorophores covalently bonded to a dendrimer core.

11. The electrophoretic display of claim 1, wherein the charged fluorescent dendrimer comprises:
an anionic fluorophore covalently bonded to a dendrimer core,
wherein the fluorophore is a derivative of a charged fluorophore molecule comprising at least one amine-reactive carbonyl functional group,
wherein the dendrimer core is a derivative of a dendrimer molecule comprising at least one surface reactive amine functional group, and
wherein the at least one surface reactive amine functional group of the dendrimer molecule is configured to react with the at least one amine-reactive carbonyl functional group of the charged fluorophore molecule to covalently link the dendrimer molecule with the charged fluorophore molecule.

12.-13. (canceled)

14. The electrophoretic display of claim 1, wherein the charged fluorescent dendrimer comprises at least one charged fluorophore covalently bonded to a dendrimer core, wherein the dendrimer core comprises a derivative of a dendrimer molecule having:
a central core comprising a first molecular species having at least two first reactive sites; and
at least a second molecular species covalently bonded at each of the at least two first reactive sites of the first molecular species to provide a 0th generation dendrimer, wherein each of the second molecular species comprises at least two additional reactive sites configured for attachment of one additional generation of the second molecular species to the 0th generation of the second molecular species.

15. The electrophoretic display of claim 11, wherein the derivative of the dendrimer molecule comprises m generations of the second molecular species and the m^{th} generation comprises the at least one surface reactive amine functional group.

16. (canceled)

17. The electrophoretic display of claim 11, wherein:
the at least one surface reactive amine functional group comprises a diamine of formula :N-A1-N:, wherein A1 is a substituted or non-substituted alkylene group, or a substituted or non-substituted arylene group; and
the derivative of the dendrimer molecule further comprises a second molecular species of formula -A2-CO—NH-A3-NX2, wherein X is hydrogen in an mth generation of the dendrimer molecule or X is a covalent bond in a 0th-(m−1)th generation of the dendrimer molecule, A2 is an alkylene group and A3 is a substituted or non-substituted alkylene group, or a substituted or non-substituted arylene group.

18. (canceled)

19. The electrophoretic display of claim 11, wherein the derivative of the dendrimer molecule has a central core of (X-Yₙ) wherein X comprises a first molecular species having n substantially symmetrically disposed first functional groups, Y comprises a second molecular species having at least two second functional groups reactive with the first functional groups, n is the number of units of Y bonded to X, and the dendrimer molecule has a branching repeating structure of at least m generations of repeating units of (X-Yₙ₋₁) wherein n−1 is the number of units of Y bonded to X, and the units Y in the m^{th} generation of the repeating units comprise the at least one surface reactive amine.

20. The electrophoretic display of claim 11, wherein:
the derivative of the dendrimer molecule is a 1 to 10 generation dendrimer having a central core of (X-Yₙ), wherein
X is 1,3,5-triazine; and
Y is a diaminyl terminated moiety selected from the group consisting of aminomethylpiperidine, diaminodipropylamine, aminopiperidine, aminopyrrolidine, aminoalkylpiperidine, diaminodialkylamine, aminoalkylpyrrolidine, 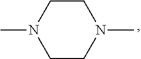
and —NH-A-NH, wherein A is C₂ to C₁₀ alkylene.

21.-24. (canceled)

25. The electrophoretic display of claim 1, wherein the at least one electrically charged particle is configured to emit red-colored electromagnetic radiation, and the charged fluorophore molecule is at least one of

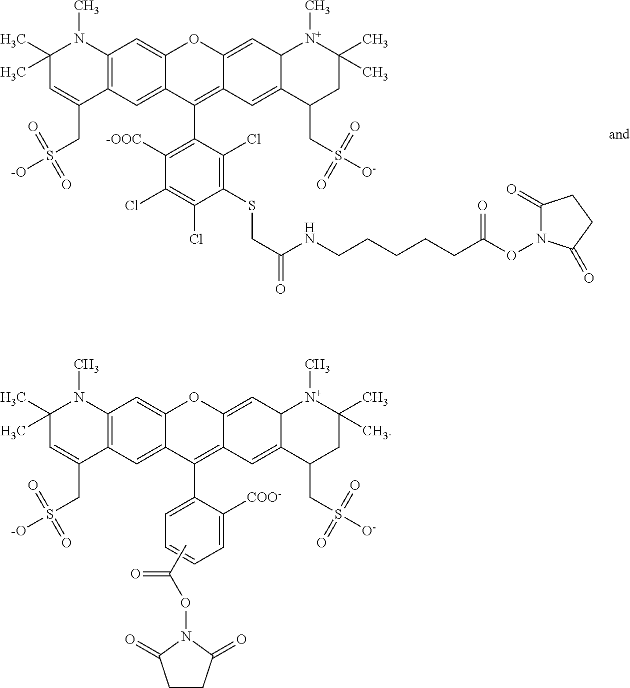

26. The electrophoretic display of claim 1, wherein the at least one electrically charged particle is configured to emit green-colored electromagnetic radiation, and the charged fluorophore molecule is at least one of

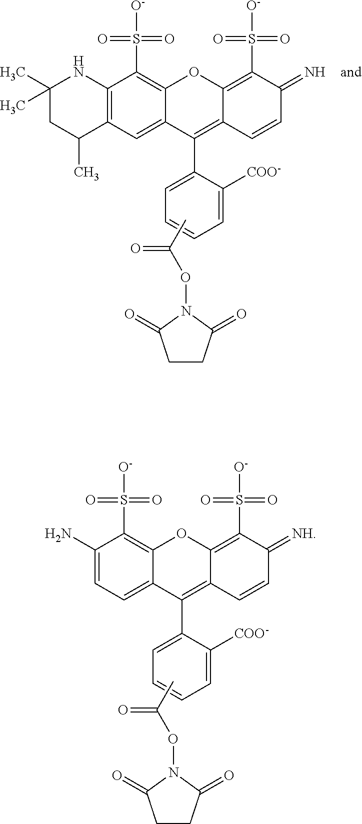

27. The electrophoretic display of claim 1, wherein the at least one electrically charged particle is configured to emit blue-colored electromagnetic radiation, and the charged fluorophore molecule is at least one of

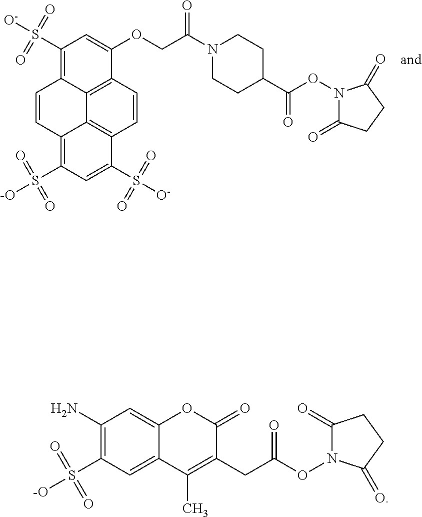

28. The electrophoretic display of claim 1, wherein the at least one electrically charged particle is configured to emit yellow-colored electromagnetic radiation, and the charged fluorophore molecule comprises

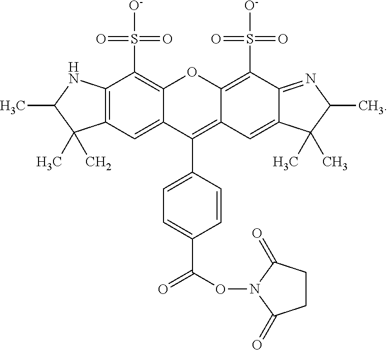 [SMILES: CC1N=c2c(cc3c(c2S(=O)(=O)[O-])Oc2c(cc4c(c2S(=O)(=O)[O-])NC(C)C4(C)C)C=3c2ccc(C(=O)ON3C(=O)CCC3=O)cc2)C1(C)C]

29. The electrophoretic display of claim 1, wherein the at least one electrically charged particle is configured to emit yellow-green-colored electromagnetic radiation, and the charged fluorophore molecule comprises

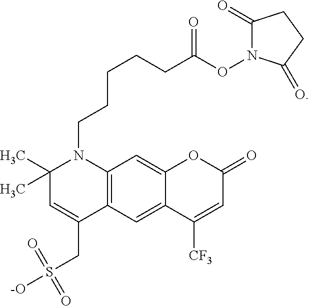

30. The electrophoretic display of claim 1, further comprising:
a first substrate with a first surface, wherein the at least one first electrode layer is disposed on the first surface of the first substrate;
a second substrate with a second surface, wherein the second substrate is spaced apart from and opposite to the at least one first substrate to define a chamber between the first substrate and the second substrate;
a second electrode layer disposed on the second surface of the second substrate such that the second electrode layer faces the at least one first electrode layer; and
at least one microcapsule located in the chamber between the first and second electrode layers, wherein the at least one microcapsule is contained in the electrophoretic medium.

31.-104. (canceled)

105. A method for producing a charged fluorescent particle, the method comprising:
reacting a charged fluorophore with a dendrimer,
wherein the fluorophore comprises at least one amine-reactive carbonyl group selected from the group consisting of: aldehyde, ketone, carboxylic acid, ester, acyl halide, anhydride, and combinations thereof, and
the dendrimer comprises at least one surface reactive amine, and
wherein the at least one surface reactive amine of the dendrimer reacts with the at least one amine-reactive carbonyl group of the fluorophore to covalently bond the dendrimer with the fluorophore to form the charged fluorescent particle.

106. The method of claim 105, wherein:
reacting the charged fluorophore with the dendrimer comprises reacting the dendrimer with a charged fluorophore comprising at least one of: 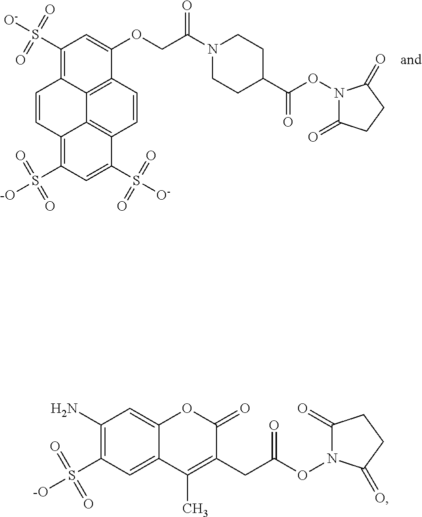
such that the charged fluorescent particle is formed capable of emitting blue-colored electromagnetic radiation.

107. The method of claim 105, wherein:
reacting the charged fluorophore with the dendrimer comprises reacting the dendrimer with a charged fluorophore comprising at least one of: 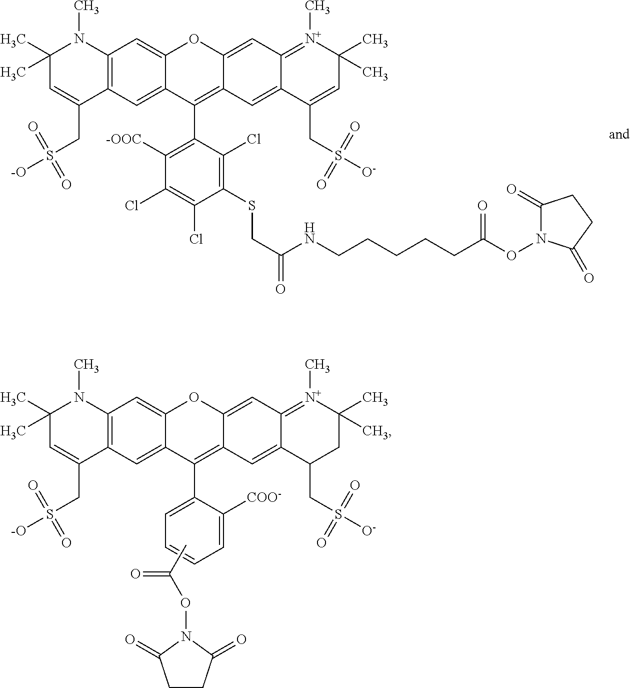
such that the charged fluorescent particle formed is capable of emitting red-colored electromagnetic radiation.

108. The method of claim 105, wherein:
reacting the charged fluorophore with a dendrimer comprises reacting the dendrimer with a charged fluorophore comprising at least one of: 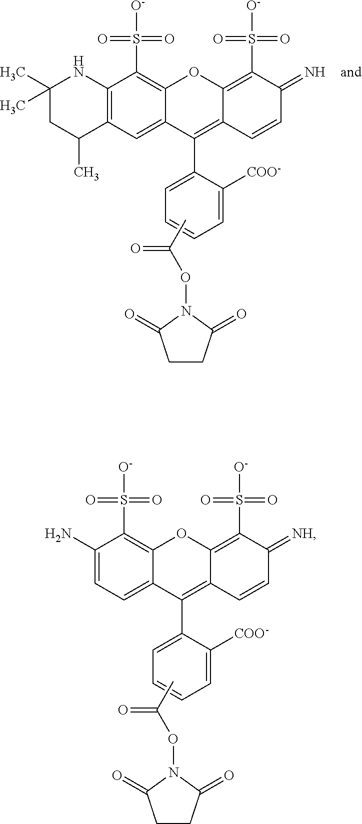
such that the charged fluorescent particle formed is capable of emitting green-colored electromagnetic radiation.

109. The method of claim 105, wherein:
reacting the charged fluorophore with the dendrimer comprises reacting the dendrimer with a charged fluorophore comprising 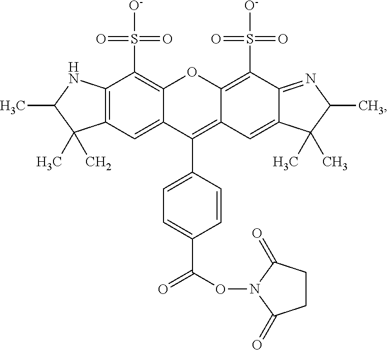 [SMILES: CC1N=c2c(cc3c(c2S(=O)(=O)[O-])Oc2c(cc4c(c2S(=O)(=O)[O-])NC(C)C4(C)C)C=3c2ccc(C(=O)ON3C(=O)CCC3=O)cc2)C1(C)C]
such that the charged fluorescent particle formed is capable of emitting yellow-colored electromagnetic radiation.

110. The method of claim 105, wherein:
reacting the charged fluorophore with the dendrimer comprises reacting the dendrimer with a charged fluorophore comprising 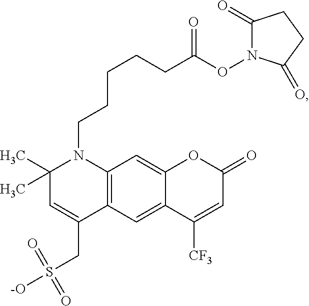
such that the charged fluorescent particle formed is capable of emitting yellow-green colored electromagnetic radiation.

111. The method of claim 105, further comprising:
forming the dendrimer, wherein forming the dendrimer comprises:
providing a core molecule;
adding a 0^{th} generation of molecular units to the core molecule to form a 0^{th} generation dendrimer; and
successively adding additional generations of molecular units to a previous generation of molecular units to produce an m^{th} generation dendrimer having m generations of the molecular units; and
wherein reacting the charged fluorophore with the dendrimer covalently bonds the fluorophore to the m^{th} generation of molecular units.

112. (canceled)

113. The method of claim 111, wherein providing the core molecule comprises providing a core molecule comprising cyanuric chloride and the method further comprises:
adding the 0^{th} generation molecular units to the core molecule by:
reacting the cyanuric chloride with a mono-protected diamine to replace chlorine moieties of the cyanuric chloride with the diamine; and
deprotecting the diamine to form the 0^{th} generation dendrimer.

114. The method of claim 111, wherein successively adding additional generations of molecular units comprises:
A) reacting the 0^{th} generation dendrimer with cyanuric chloride to bond the cyanuric chloride to each diamine;
B) reacting the cyanuric chloride bonded to the diamine with additional mono-protected diamine to replace chlorine moieties of the cyanuric chloride bonded to the diamine; and
C) deprotecting the diamine to produce the additional generation of the dendrimer; and
D) repeating step A, step B and step C (m−1) additional times to produce the (m^{th}) generation dendrimer comprising free-reactive amines in the (m^{th}) generation.

115.-118. (canceled)

119. The method of claim 111, wherein:
providing a core molecule comprises providing a core molecule having a first diamine;
adding the 0^{th} generation of molecular units comprises:
A) contacting the first diamine with methyl acrylate to covalently bond the methyl acrylate with an amine nitrogen of the first diamine to produce a methyl acrylate substituted diamine; and
B) contacting the methyl acrylate substituted diamine with a second diamine to produce an amidoamine as the 0^{th} generation of molecular units; and
successively adding additional generations of molecular units comprises repeating the steps of A and B for each generation.

120. The method of claim 119, wherein contacting the first diamine and contacting the second diamine comprises contacting a diamine selected from the group consisting of: aminomethylpiperidine, diaminodipropylamine, aminopiperidine, aminopyrrolidine, aminoalkylpiperidine, diaminodialkylamine, aminoalkylpyrrolidine, 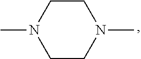
and —NH-A-NH— wherein A is a substituted or unsubstituted alkylene, and a substituted or unsubstituted arylene.
